(19) United States
(12) Patent Application Publication
(10) Pub. No.: US 2013/0018543 A1
(43) Pub. Date: Jan. 17, 2013

(54) ELECTRONIC CONTROL APPARATUS

(71) Applicant: Naohiro TOHYAMA, Ichinomiya-city (JP)

(72) Inventor: Naohiro TOHYAMA, Ichinomiya-city (JP)

(73) Assignee: DENSO CORPORATION, Kariya-city (JP)

(21) Appl. No.: 13/540,973

(22) Filed: Jul. 3, 2012

(30) Foreign Application Priority Data
Jul. 12, 2011 (JP) 2011-153996

(51) Int. Cl. G06F 7/00

(52) U.S. Cl. 701/33.4

(57) ABSTRACT

In an electronic control apparatus in a vehicle, while an operational state where an engine rotation speed is equal to or greater than a determination value continues during a vehicle stop state where an accelerator of the vehicle is in an OFF state, a condition satisfying counter is incremented. In cases that (i) a value of the condition satisfying counter becomes longer than a determination period, and (ii) a storage history flag indicates “0”, an additional value is added to the determination period. This lengthens the determination period that is used for comparing with the condition satisfying counter. Further, travel information at this time is stored in a storage portion; the storage history flag is set to “1”. While the storage history flag indicates “1”, another travel information is not stored into the storage portion.

### CROSS REFERENCE TO RELATED APPLICATION

This application is based on Japanese Patent Application No. 2011-153996 filed on Jul. 12, 2011, the disclosure of which is incorporated herein by reference.

### TECHNICAL FIELD

The present disclosure relates to an electronic control apparatus that stores travel information of a vehicle in order to analyze a cause of an occurrence of a vehicle behavior.

### BACKGROUND

[Patent document 1] U.S. Pat. No. 5,754,965

Patent document 1 discloses a technology to diagnose a vehicle behavior from detection signals of various in-vehicle sensors and analyze an occurrence cause of the vehicle behavior. A known technology stores as travel information the output information of the various sensors before and after a vehicle collision when an impact is applied to the vehicle because of the vehicle collision etc.

Another known technology stores as travel information (freeze frame data) (i) a diagnosis code corresponding to an anomalous condition and (ii) a sensor output or control data on a time axis of the anomalous state when the anomalous state occurs in a sensor or actuator.

However, the diagnosis code and freeze frame data are stored in cases that an anomaly occurs in the sensor, actuator, or the like. Although no anomaly arises in the sensor or actuator, an anomalous vehicle behavior may occur which is considered not to arise in a driver's usual driving operation. In such a case, any travel information at the occurrence of the anomalous vehicle behavior may not be recorded. As a result, even if an anomalous vehicle behavior occurs, the cause is unanalyzable based on the travel information.

### SUMMARY

The inventor has studied a technology below. There is an anomalous vehicle behavior, which satisfies a predetermined determination condition and which is considered not to arise in a usual driving operation. The studied technology is to analyze such an anomalous vehicle behavior based on the travel information which was stored at the time when the anomalous vehicle behavior continues for a continued period that is longer than a predetermined determination period.

The inventor of the present application realizes that a vehicle behavior, which satisfies the determination condition and continues for a continued period longer than the determination period, may repeatedly occur depending on the driving characteristic of the vehicle or the tendency of the driving operation of the driver, thereby causing the repeated storage of the travel information.

When the travel information is repeatedly stored and the storage capacity is limited, the stored travel information is overwritten. As a result, the travel information, which was stored when an anomalous vehicle behavior considered not to arise in a usual driving operation arose, is overwritten; thus, the occurrence cause of the anomalous vehicle behavior may not be analyzable.

In order to prevent the travel information from being stored repeatedly, the determination condition or determination period may be designated to suit the driving characteristic of the vehicle or the tendency of the driving operation of the driver. However, it is not so easy to suit all the driving characteristic of the vehicle or the tendency of the driving operation of the driver.

It is an object of the present disclosure to provide an electronic control apparatus to store travel information of a vehicle at a time when an anomalous vehicle behavior, which satisfies a determination condition, continues for a continued period longer than a determination period, and analyze an occurrence cause of the anomalous vehicle behavior while suppressing a storage of unnecessary travel information.

To achieve the above object, according to an example of the present disclosure, an electronic control apparatus for a vehicle is provided as follows. A behavior determination section is included to determine whether an anomalous vehicle behavior, which satisfies a determination condition, continuously arises for a continued period that is longer than a determination period. A travel information storage section is included to store, in a storage portion, travel information of the vehicle at a time when the behavior determination section determines that the anomalous vehicle behavior continuously arises for the continued period longer than the determination period. A period change section is included to change the determination period to a lengthened determination period by lengthening the determination period in cases that the behavior determination section determines that the anomalous vehicle behavior continuously arises for the continued period longer than the determination period.

Thus, under the configuration of the example of the present disclosure, when an anomalous vehicle behavior, which satisfies the determination condition, continues for a continued period that is longer than the determination period, the travel information at that time is stored. The occurrence cause of the anomalous vehicle behavior is thus analyzed based on the stored travel information.

Furthermore, the determination period may be lengthened. Thereby, even when a vehicle behavior which satisfies the same determination condition occurs, any new travel information is not stored unless the vehicle behavior continues for a continued period longer than the lengthened determination period. Thus, it becomes more difficult for the travel information to be stored in the storage portion. This suppresses the storage of the unnecessary travel information.

### BRIEF DESCRIPTION OF THE DRAWINGS

The above and other objects, features, and advantages of the present disclosure will become more apparent from the following detailed description made with reference to the accompanying drawings. In the drawings:

FIG. 1 is a block diagram illustrating an overall configuration of an electronic control apparatus according to an embodiment of the present disclosure;

FIG. 2 is a flowchart diagram for illustrating a travel information storage process 1;

FIG. 3A is a flowchart diagram for illustrating a learnt value storage process 1 of a determination period at the time of an engine stop;

FIG. 3B is a flowchart diagram for illustrating a learnt value setup process 1 of a determination period at the time of an engine start;

FIG. 4 is a flowchart diagram for illustrating a travel information storage process 2;

FIG. 5 is a flowchart diagram for illustrating a travel information storage process 3;

FIG. 6A is a flowchart diagram for illustrating a learnt value storage process 2 of a determination period and a determination condition at the time of an engine stop;

FIG. 6B is a flowchart diagram for illustrating a learnt value setup process 2 of a determination period and a determination condition at the time of an engine start;

FIG. 7 is a flowchart diagram for illustrating a travel information storage process 4; and

FIG. 8 is a flowchart diagram for illustrating a learnt value storage process 3 of a determination period at the time of an engine stop.

### DETAILED DESCRIPTION

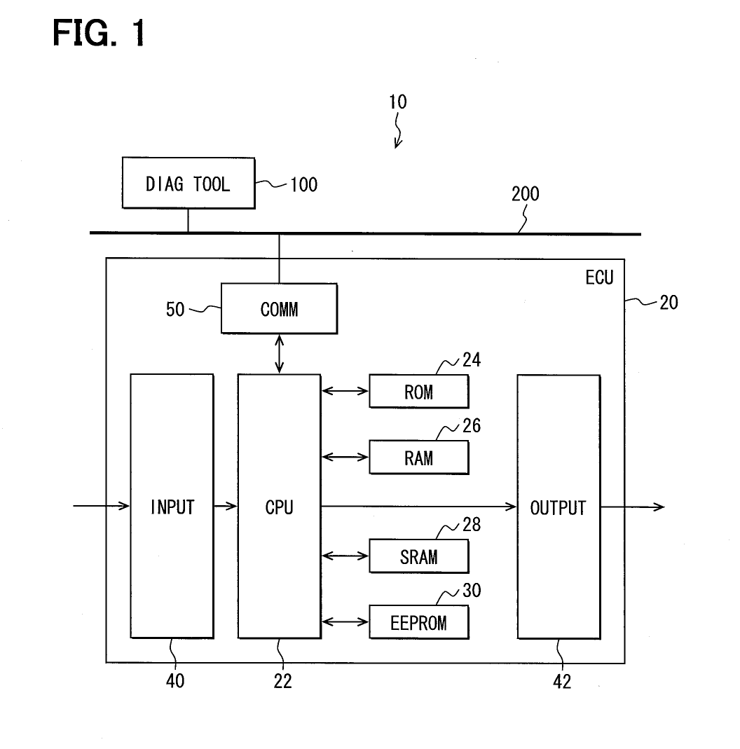

The following describes an embodiment of the present disclosure with reference to drawings. FIG. 1 illustrates a vehicle diagnostic system 10 using an electronic control apparatus 20 (also referred to as an electronic control unit (ECU)) of the present embodiment mounted in a vehicle. The vehicle diagnostic system 10 includes the ECU 20 and a diagnostic tool 100.

The ECU 20 is, for instance, an engine ECU which executes an injection control of an injector, and an ignition control of a spark plug. The ECU 20 includes a CPU 22, a ROM 24, a RAM 26, a SRAM (i.e., standby RAM) 28, an EEPROM 30, an input circuit 40, an output circuit 42, and a communication circuit 50.

The CPU 22 of the ECU 20 executes a control program stored in the ROM 24; thereby, the ECU 20 receives an accelerator opening, an engine rotation frequency, a vehicle speed, a crank angle, a brake signal, an ignition signal, etc., from the various sensors via the input circuit 40. The ECU 20 outputs control signals for an injection control of the injector, and an ignition control of the spark plug via the output circuit 42 based on the detection signals from the sensors.

The RAM 26 is used by the control program of the ECU 20 as a work area; when the ignition switch is turned off, the electric power supply to the RAM 26 is shut down and the stored data in the RAM 26 disappears. In contrast, unlike in the case of the RAM 26, the SRAM 28 is supplied with an electric power from a battery regardless of the ON state or OFF state of the ignition switch. Therefore, unless the electric power supply is shut down because of the exchange of the battery, the SRAM 28 can hold the stored data.

The EEPROM 30 is a writable non-volatile storage portion. Even if the electric power supply is shut down from the battery, the data stored in the EEPROM 30 is held. The communication circuit 50 communicates with other ECUs mounted in the vehicle via a communication line 200 serving as an in-vehicle LAN such as CAN (Controller Area Network), and transmits the information stored in the SRAM 28 or the EEPROM 30 to the diagnostic tool 100 via the communication line 200.

The diagnostic tool 100 mainly includes a microcomputer which has a CPU, ROM, RAM, etc. The diagnostic tool 100 is connected to the communication line 200. The diagnosis tool 100 reads the travel information from the ECU 20 and outputs the read information to a display. The read travel information is one at a time when a vehicle behavior occurs. The vehicle behavior is to be mentioned later.

The following will explain various sections (also referred to as devices or means) that the ECU 20 functions as by the CPU 22 executing a control program stored in the ROM 24.

(Behavior Determination Section)

The ECU 20 previously designates the following determination conditions such as (1) and (2) with respect to a vehicle behavior. The ECU 20 determines whether a vehicle behavior which satisfies the determination condition continues for a continued period that is longer than a determination period based on the detection signals from the various sensors. The vehicle behaviors are considered to be an anomalous vehicle behavior which is not generated from a usual driving operation.

(1) An engine rotation frequency goes up beyond a determination value although the accelerator pedal is not stepped on during a vehicle stop.

(2) The accelerator pedal and the brake pedal are simultaneously stepped on during a vehicle travel, in particular, in the case of the vehicle of an automatic transmission (AT).

(Travel Information Storage Section)

A time point when an anomalous vehicle behavior, which satisfies the determination condition mentioned above, continues for a continued period that is longer than the determination period is defined as a continuation determination time point of a continued anomalous vehicle behavior. At the continuation determination time point of a continued anomalous vehicle behavior, the ECU 20 stores in the SRAM 28 the instant travel information that takes place at this time. The travel information includes an accelerator opening, an engine rotation frequency, a throttle opening, a shift position of transmission, a suction amount, an inlet gas temperature, a water temperature, and a vehicle speed. The travel information may be stored in the EEPROM 30 instead of the SRAM 28.

In the present application, “information” that is primarily uncountable is additionally defined as being identical to “information item” that is countable. Thus, “an information” and “informations” are used herein as being identical to “an information item” and “information items,” respectively.

Another information may be stored as the travel information in addition to the information indicating the driving states of the vehicle. For instance, when an in-vehicle camera and a navigation apparatus are mounted in the vehicle, the travel information may include a travel state of another vehicle in the circumference based on the analysis result of an image data captured by the in-vehicle camera, and shapes or configurations of travel roads such as a curvature and a slope based on map data information.

A vehicle behavior, which continues for a continued period longer than a determination period while satisfying a determination condition, takes place repeatedly; in other words, multiple continued anomalous vehicle behaviors may take place one by one in a time axis in one trip. In the present embodiment, in such a case, the newest travel information is written over the previous travel information and is stored. If the storage capacity has a margin, the multiple travel information items at multiple continuation determination time points when the continued anomalous vehicle behavior is determined are stored in order; the older information may be overwritten by a FIFO (First In First Out).

(Period Change Section)

As explained above, the ECU 20 stores, in the SRAM 28, the travel information at the continuation determination time point when a vehicle behavior which satisfies determination condition continues for a continued period longer than a present determination period, which is used at the present determination process. In such a case, the ECU 20 lengthens the present determination period to thereby obtain a lengthened determination period as a next determination period that is used for the vehicle behavior determination section at the next determination process, in one of the following methods. Even if any method is used, the lengthened determination period serving as a next determination period is provided not to exceed an upper limit value. (1) A next determination period used at a next determination process is obtained by adding a fixed value to a present determination at a present determination process. (2) A next determination period used at a next determination process is obtained by using an actual continued period for which a vehicle behavior which satisfies a determination condition has continued actually at a present determination process.

(Condition Change Section)

In addition to the determination period change process by the period change section, the ECU 20 changes a threshold value of the determination condition in a direction in which it becomes more difficult for a vehicle behavior to satisfy the determination condition, in cases that a vehicle behavior, which satisfies the determination condition, continues for a continued period longer than the determination period.

For instance, there may be a case that although the accelerator pedal is not stepped on during a vehicle stop, an engine rotation frequency not less than 2000 rpm continues longer than 2 seconds. In such a case, the present determination period of 2 seconds is changed to the next determination period of 2.5 seconds; the present threshold value of the determination condition of 2000 rpm is changed to the next threshold value of the determination condition of 2500 rpm.

(Travel Information Storage Process 1)

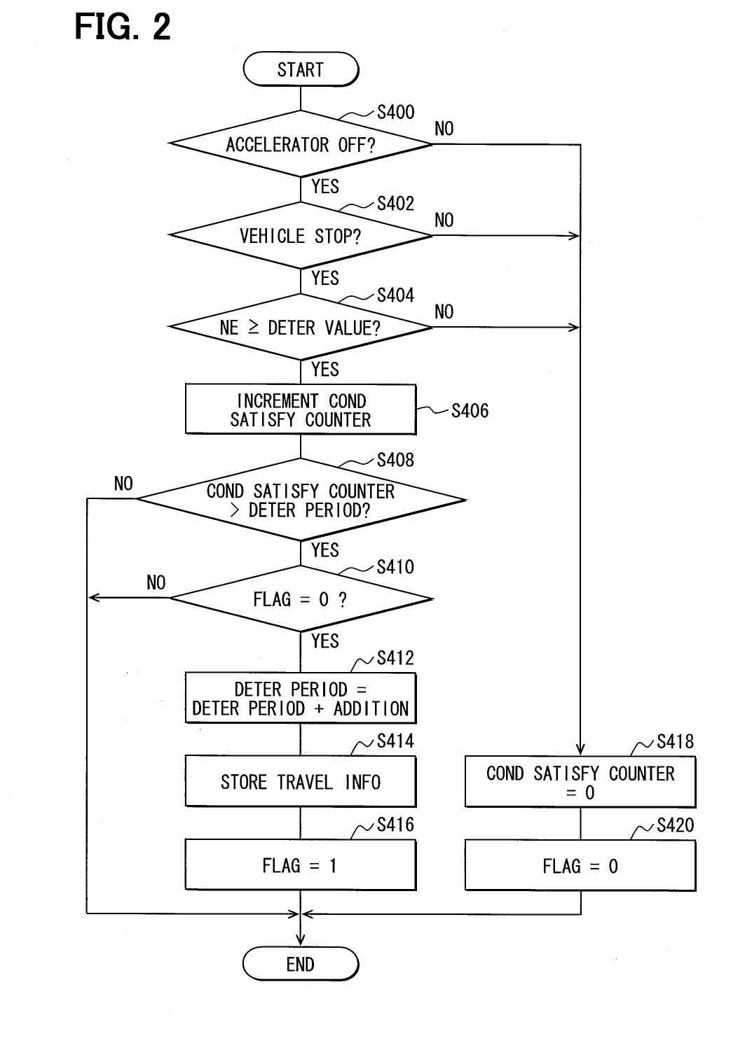

FIG. 2 is a flowchart of a travel information storage process 1 to store travel information at a time (i.e., continuation determination time point) when an anomalous vehicle behavior which satisfies a determination condition continues for a continued period longer than the determination period. The flowchart of FIG. 2 is periodically executed by a timer interrupt or by being invoked within a main control routine.

It is further noted that a flowchart or the processing of the flowchart in the present application includes sections (also referred to as steps), which are represented, for instance, as S400. Further, each section can be divided into several sub-sections while several sections can be combined into a single section. Furthermore, each of thus configured sections can be referred to as a device, module, or means and achieved not only (i) as a software section in combination with a hardware device (e.g., computer), but also (ii) as a hardware section, including or not including a function of a related apparatus. Further, the hardware section may be inside of a microcomputer.

First, the ECU 20 determines whether an engine rotation frequency (NE) is equal to or greater than a determination value during the vehicle stop in the state where the accelerator is in an OFF state (hereinafter, referred to as the state of the accelerator-off) (S400, S402, S404). The vehicle behavior in which an engine rotation frequency exceeds the determination value during the vehicle stop in the state of accelerator-off is an anomalous vehicle behavior which is not generated in a usual driving operation.

During the duration of the operation state in which the engine rotation frequency is equal to or greater than the determination value during the vehicle stop in the state of accelerator-off (S400: Yes, S402: Yes, S404: Yes), the ECU 20 increments the condition satisfying counter (S406). Further, the ECU 20 determines whether the value of the condition satisfying counter is equal to or greater than the determination period (S408), and whether the storage history flag is “0” (S410). When the value of the condition satisfying counter is less than the determination period (S408: No), or when the storage history flag is not “0” (S410: No), the ECU 20 ends the present process. The initial value (i.e., default value) of the determination period is designated, for example, as 2 seconds (2000 ms).

The value of the condition satisfying counter may be an actual time unit such as 2000 ms or a simple numerical counter value (1, 2, . . . ). In the case of using the time unit for the condition satisfying counter, an actual time unit is used also for the determination period compared with the condition satisfying counter at S408, an additional value, a period learnt value, and an upper limit value, which are explained later. In the case of using a simple numerical counter value for the condition satisfying counter, a simple numerical counter value is used also for the determination period, the additional value, the period learnt value, and the upper limit value.

The value of the condition satisfying counter is equal to or greater than the determination period (S408: Yes), and the storage history flag indicates “0” (S410: Yes). In this case, the ECU 20 adds an additional value, which is a predetermined fixed value, to the determination period (S412), stores travel information in the SRAM 28 (S414), sets the storage history flag to “1” (S416), and ends the present process. The additional value is designated, for example, as fixed 500 ms.

The storage history flag is set to “0”, when one of the determinations at S400, S402, and S404 is “No.” When the determination at S408 is “Yes” in the status of “0”, the storage history flag is set to “1”. Once the storage flag is set to “1”, the status of “1” continues until one of the determinations at S400, S402, and S404 becomes “No.”

During the storage history flag being in the status of “1”, the processing at S414 is not executed even when the value of the condition satisfying counter is longer than the determination period. The travel information is thus not stored. When one of the determinations at S400, S402, and S404 is “No,” the ECU 20 clears the condition satisfying counter and the storage history flag, and sets them to “0” (S418, S420).

In the travel information storage process 1 of FIG. 2, when an anomalous vehicle behavior, which satisfies the determination condition that the engine rotation frequency is equal to or greater than the determination value in the state of accelerator-off during the vehicle stop, continues for a continued period that is longer than the determination period, the travel information at that time (i.e., at the continuation determination time point) is stored in the SRAM 28. Thus, when the travel of the vehicle stops, the travel information stored in the SRAM 28 is read out using the diagnostic tool 100. The analysis of the occurrence cause can be made for an anomalous vehicle behavior that does not result from a usual driving operation. For instance, the anomalous vehicle behavior signifies that the state, where the engine rotation frequency is equal to or greater than the determination value in the state of accelerator-off during the vehicle stop, continues for a continued period that is longer than the determination period.

Further, when an anomalous vehicle behavior, where the engine rotation frequency is equal to or greater than the determination value in the state of accelerator-off during the vehicle stop, continues for a continued period that is longer than the determination period, the determination period is lengthened by an additional value. Thus, the travel information is not stored unless the operational state where the engine rotation frequency is equal to or greater than the determination value during the stop in the state of accelerator-off continues longer than the continued period of this time. Thus, it becomes more difficult for the travel information to be stored in the storage portion. This suppresses the storage of the unnecessary travel information.

The lengthened determination period is provided by adding a fixed additional value to the determination period even when the continued period of the anomalous vehicle behavior, which satisfies the determination condition that the engine rotation frequency is equal to or greater than the determination value in the state of accelerator-off during the vehicle stop, is longer than the lengthed determination period. The lengthened determination period is prevented from becoming longer rapidly even if the vehicle behavior having a very long continued period occurs suddenly.

The travel information storage process 1 of FIG. 2 is executed by the ECU 20 or the CPU 22 of the ECU 20. Thus, the ECU 20 or the CPU 22 may function as a behavior determination section, device, or means by executing the process at S400 to S404, and S408. Further, the ECU 20 or the CPU 22 may function as a period change section, device, or means by executing the process at S412. Further, the ECU 20 or the CPU 22 may function as a travel information storage section, device, or means by executing the process at S414.

(Learnt Value Storage Process 1 and Learnt Value Setup Process 1)

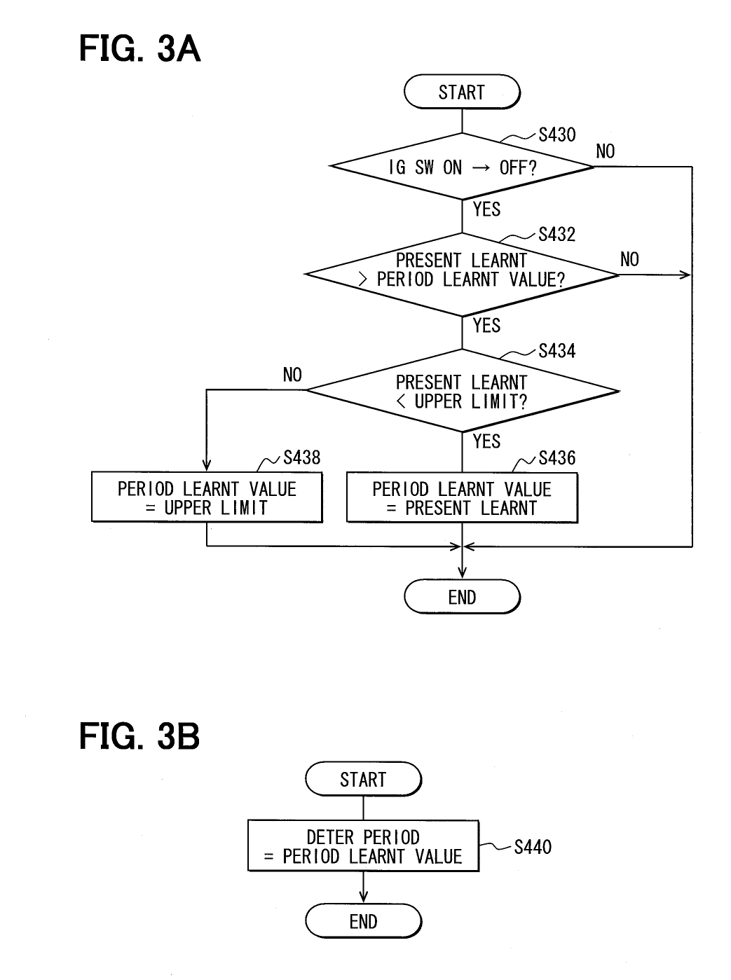

FIG. 3A is a flowchart of a learnt value storage process 1 for a determination period at the time of stopping the engine (also referred to as at the engine stop time point) corresponding to the travel information storage process 1 of FIG. 2. FIG. 3B is a flowchart of a learnt value setup process 1 for a determination period at the time of starting the engine (also referred to as at the engine start time point). A trip may be defined as being from the engine start time point to the engine stop time point. The learnt value storage process 1 and the learnt value setup process 1 in FIGS. 3A, 3B serve as a process which hands over a learnt value of the determination period learned in a present trip to a next trip.

With reference to FIG. 3A, when the ignition switch is turned from an ON state to an OFF state and the engine stops to thereby end a present trip (S430: Yes), it is determined whether a determination period learned at the present trip (also referred to a present learnt determination period) is longer than a period learnt value of the previous trip (S432). The previous trip is earlier than the present trip by one trip. When it is determined that the present learnt determination period is not longer than the period learnt value of the previous trip (S432: No), the ECU 20 ends the present process. Therefore, the determination period used at the time of starting the engine at the next trip is the period learnt value of the previous trip. The next trip is later than the present trip by one trip. In other words, the previous trip, the present trip, and the next trip take place in this order on a time axis. An initial value of the period learnt value is set to 2000 ms that is the same as an initial value of the determination period.

When the present learnt determination period is longer than the period learnt value (S432: Yes), the ECU 20 determines whether the present learnt determination period is shorter than an upper limit value (S434). The upper limit value of the determination period is, for example, set to 4000 ms.

When the present learnt determination period is shorter than the upper limit (S434: Yes), the present learnt determination period is designated as the period learnt value (S436). When the present learnt determination period is not shorter than the upper limit (S434: No), the upper limit value is designated as the period learnt value (S438). The period learnt value is stored in the SRAM 28 or EEPROM 30.

In FIG. 3B, when the ignition switch is turned from the OFF state to the ON state and the engine starts, the ECU 20 designates the period learnt value stored in FIG. 3A as the determination period (S440).

In the learnt value storage process 1 of FIG. 3A, and the learnt value setup process 1 of FIG. 3B, the determination period resulting from learning at the past trip(s) is stored in the SRAM 28 or EEPROM 30 as the period learnt value. Thus, the determination period resulting from the learning can be handed over the trips.

In the learnt value storage process 1 of FIG. 3, the ECU 20 or the CPU 22 may function as a period change section, device, or means by executing the process at S432 to S440.

(Travel Information Storage Process 2)

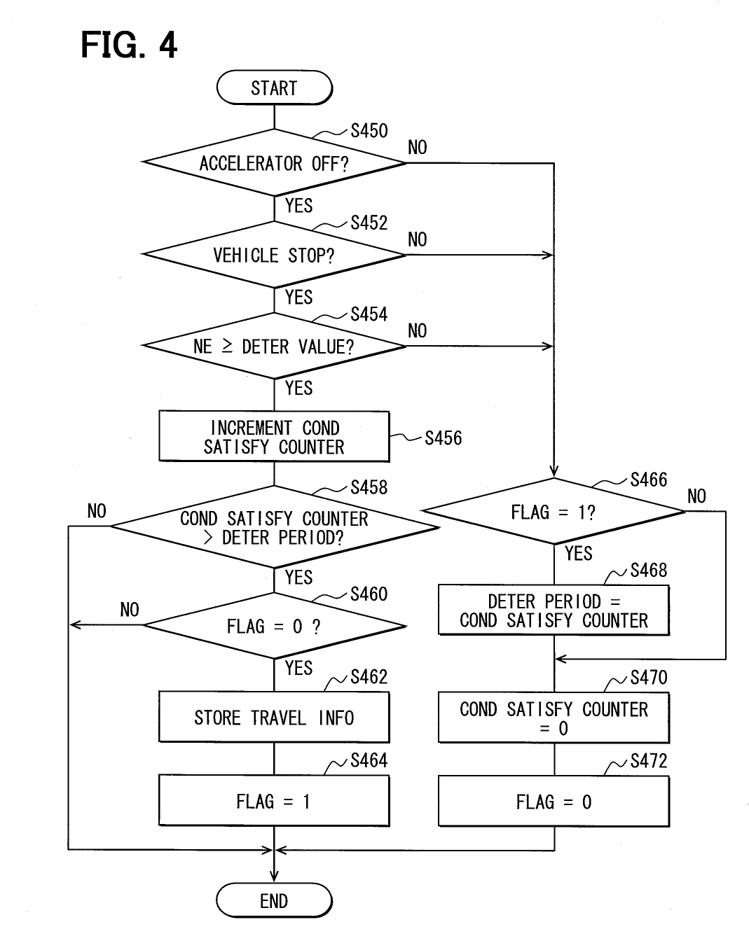

FIG. 4 is a flowchart of the travel information storage process 2. The flowchart of FIG. 4 is periodically executed by a timer interrupt or by being invoked within a main control routine. In FIG. 4, S450 to S464, S470, and S472 are substantially the same as S400 to S410, S414 to S420 of FIG. 2.

A continuation determination time point is defined as a time when an anomalous vehicle behavior, which satisfies a determination condition that the engine rotation frequency is equal to or greater than a determination value in the state of accelerator-off during the vehicle stop, continues for a continued period that is longer than a determination period (S450: Yes, S452: Yes, S454: Yes, S458: Yes). Simultaneously when the storage history flag indicates “0” (S460: Yes), the travel information at this time (i.e., at the continuation determination time point) is stored (S462) and the storage history flag is set to “1” (S464).

When one of the determinations at S450, S452, and S454 becomes “No” and the storage history flag is “1” (S466: Yes), the ECU 20 designates the value of the condition satisfying counter as the determination period (S468).

During a duration of the state where the engine rotation frequency is equal to or greater than the determination value continues during the vehicle stop in the state of accelerator-off, the condition satisfying counter is incremented at S456. That is, the state, where the engine rotation frequency is equal to or greater than the determination value, continues for a continued period during the vehicle stop in the state of accelerator-off, and the continued period becomes longer than the determination period designated previously. In this case, the continued period is designated as the determination period. Therefore, the determination period designated at S468 may increase rapidly unlike as shown in FIG. 2, where the determination period increases gradually by the fixed value.

Thus, the continued period for which the anomalous vehicle behavior continues is defined as the determination period. Therefore, the determination period can be designated with a high accuracy to meet the actual occurrence state of the vehicle behavior. In addition, the travel information is not stored unless a vehicle behavior which satisfies determination condition continues for a continued period longer than the actually undergone continued period. This can suppress, as much as possible, the travel information from being stored repeatedly.

The learnt value storage process of the determination period at the time of stopping the engine, and the learnt value setup process of the determination period at the time of starting the engine are substantially the same the FIGS. 3A, 3B, respectively; the explanation is abbreviated. In the travel information storage process 2 of FIG. 4, the ECU 20 or the CPU 22 may function as a behavior determination section, device, or means by executing the process at S450 to 454, and S458. Further, the ECU 20 or the CPU 22 may function as a travel information storage section, device, or means by executing the process at S462. Further, the ECU 20 or the CPU 22 may function as a period change section, device, or means by executing the process at S468.

(Travel Information Storage Process 3)

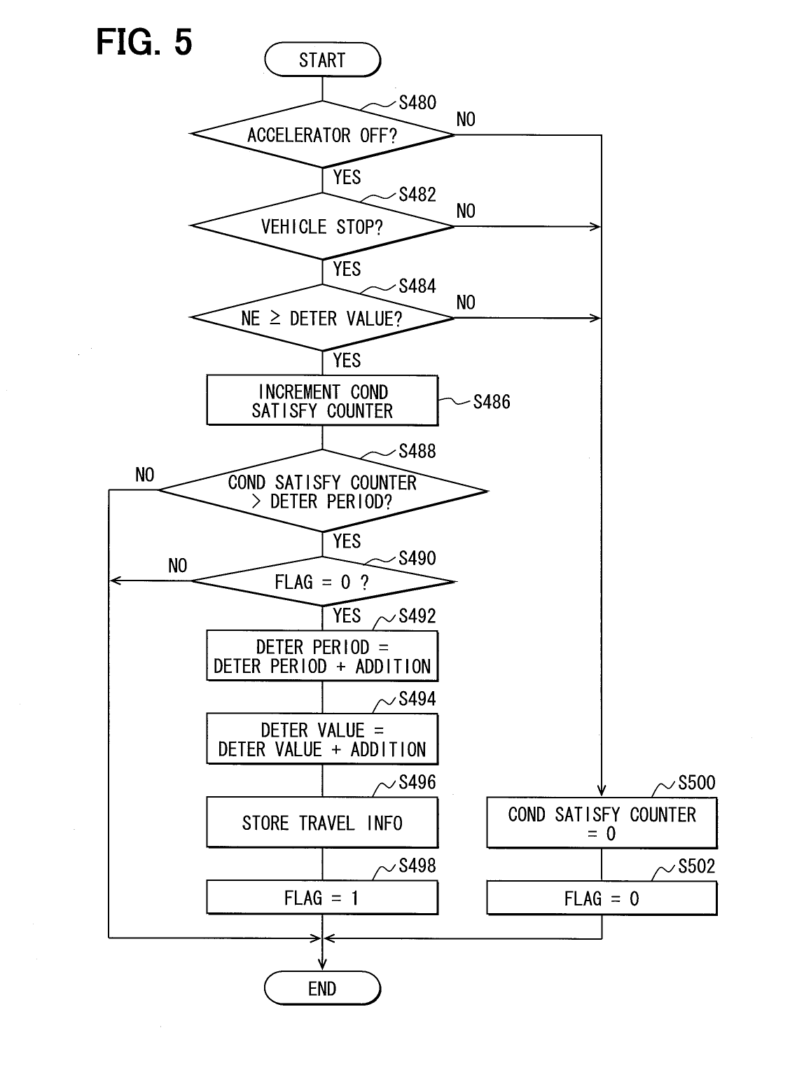

FIG. 5 is a flowchart of the travel information storage process 3. The flowchart of FIG. 5 is periodically executed by a timer interrupt or by being invoked within a main control routine. In FIG. 5, S480 to S492, S496 to S502 are substantially the same as S400 to S420 of FIG. 2.

When an anomalous vehicle behavior, which satisfies the determination condition that the engine rotation frequency is equal to or greater than the determination value in the state of accelerator-off during the vehicle stop, continues for a continued period that is longer than the determination period (S480: Yes, S482: Yes, S484: Yes, S488: Yes), the determination period is lengthened by adding a fixed additional value (S492), and the determination value used at S484 for comparison with the engine rotation frequency is increased by adding a fixed additional value (S494). The initial value of the determination value used for comparison with the engine rotation frequency is set to 2000 rpm, the fixed additional value added to the determination value is set to 200 rpm, for instance.

That is, the travel information is not stored unless the vehicle behavior, which satisfies the determination condition that the engine rotation frequency is equal to or greater than the determination value during the vehicle stop in the state of accelerator-off, continues for a continued period longer than the continued period of this time and the engine rotation frequency becomes higher than that of this time.

As a result, it becomes difficult for the vehicle behavior to satisfy the determination condition as compared with the case where the vehicle behavior which satisfies the determination period only needs to continue for a continued period that is longer than determination period; storing the travel information may be suppressed. In the travel information storage process 3 of FIG. 5, the ECU 20 or the CPU 22 may function as a behavior determination section, device, or means by executing the process at S480 to S484, and S488. The ECU 20 or the CPU 22 may function as a period change section, device, or means by executing the process at S492. The ECU 20 or the CPU 22 may function as a condition change section, device, or means by executing the process at S494. Further, the ECU 20 or the CPU 22 may function as a travel information storage section, device, or means by executing the process at S496.

In addition, the determination value used for comparison with the engine rotation frequency may be referred to as a threshold value of the determination condition of FIG. 5.

(Learnt Value Storage Process 2 and Learnt Value Setup Process 2)

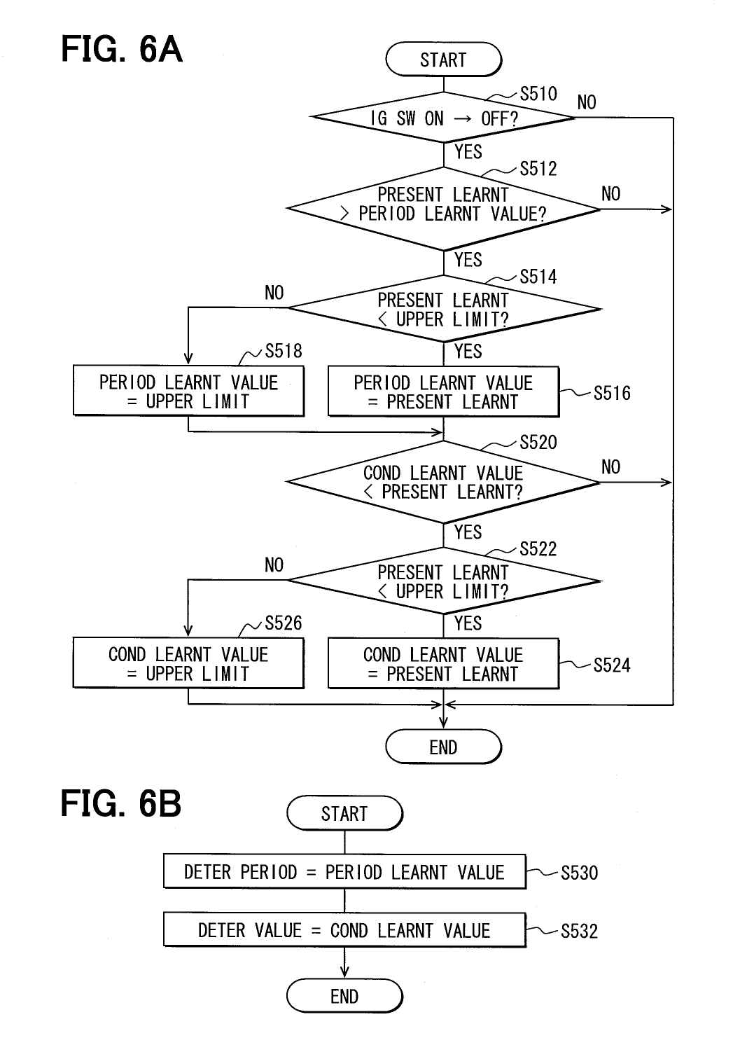

FIG. 6A is a flowchart diagram for illustrating a learnt value setup process 2 of a determination period and a determination condition at the time of stopping the engine corresponding to the travel information storage process 3 of FIG. 5. FIG. 6B is a flowchart diagram for illustrating a learnt value setup process 2 of a determination period and a determination condition at the time of starting the engine corresponding to the travel information storage process 3 of FIG. 5.

In FIG. 6A, the process at S510 to S518 is substantially the same as the process at S430 to S438 in FIG. 3A; the explanation thereto is omitted. At S520, the ECU 20 determines whether the determination value of the determination condition, that is used for comparison with the engine rotation frequency at S484 in FIG. 5 and learnt at the present trip, (also referred to as the present learnt determination value of the determination condition) is greater than a condition learnt value of the previous trip. When it is determined that the present learnt determination value is not longer than the condition learnt value of the previous trip (S520: No), the ECU 20 ends the present process. Therefore, the determination value used at the time of starting the engine at the next trip is the condition learnt value of the previous trip.

When the present learnt determination value is greater than the condition learnt value (S520: Yes), the ECU 20 determines whether the present learnt determination value is equal to or smaller than the upper limit value (S522). When determining that the present learnt determination value is equal to or smaller than the upper limit value (S522: Yes), the ECU 20 designates the present learnt determination value as the condition learnt value (S524). When the present learnt determination value is greater than the upper limit value (S522: No), the upper limit value is designated as the condition learnt value (S526). The condition learnt value is stored in the SRAM 28 or EEPROM 30.

In FIG. 6B, when the ignition switch is turned from the OFF state to the ON state and the engine starts, the ECU 20 designates the period learnt value and the condition learnt value which were designated in FIG. 6A as the determination period and the determination value, respectively (S530, S532).

In the travel information storage process 2 of FIG. 6A, the ECU 20 or the CPU 22 may function as a period change section, device, or means by executing the process at S512 to S518, and may function as a condition change section, device, or means by executing the process at S520 to S526.

(Travel Information Storage Process 4)

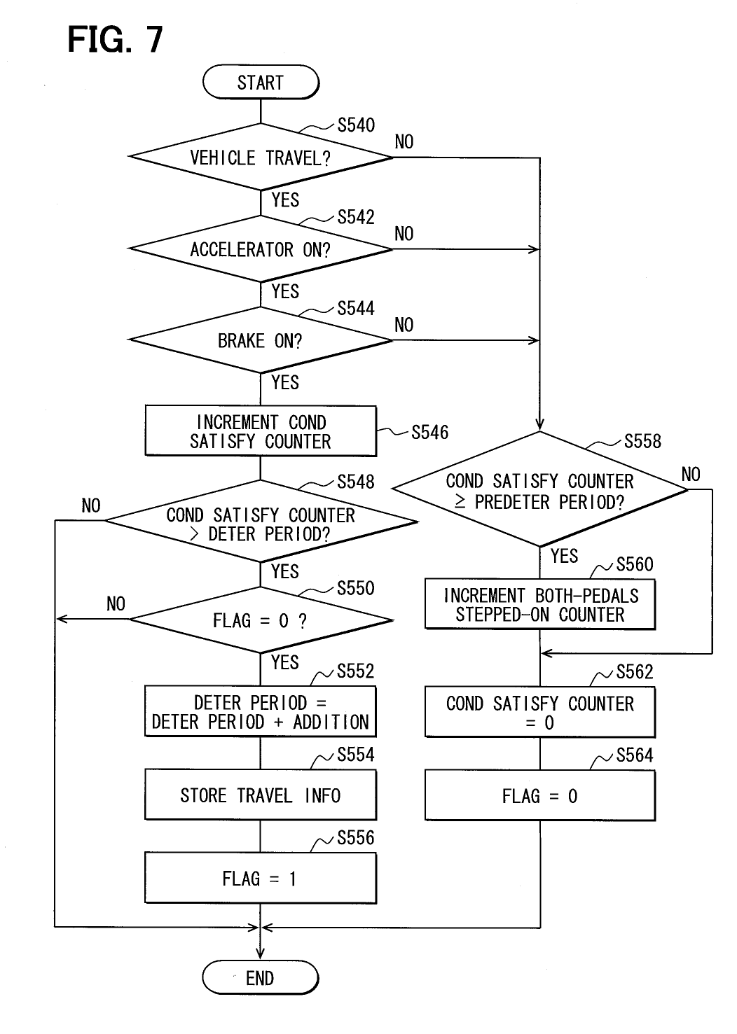

FIG. 7 is a flowchart of the travel information storage process 4. The flowchart of FIG. 7 is periodically executed by a timer interrupt or by being invoked within a main control routine.

The ECU 20 determines whether a state of accelerator-on and brake-on takes place during the travel of the vehicle (S540, S542, S544). The vehicle behavior in which the state of accelerator-on and brake-on takes place during the travel of the vehicle is an anomalous vehicle behavior which does not arise in a usual driving operation.

During a duration of the state of accelerator-on and brake-on during the travel of the vehicle (S540: Yes, S542: Yes, S544: Yes), the ECU 20 increments the condition satisfying counter (S546), determines whether the value of the condition satisfying counter is longer than the determination period (S548), and determines whether the storage history flag is “0” (S550). When the value of the condition satisfying counter is less than the determination period (S548: No), or when the storage history flag is not “0” (S550: No), the ECU 20 ends the present process.

When the value of the condition satisfying counter is longer than the determination period (S548: Yes) and the storage history flag is “0” (S550: Yes), the ECU 20 lengthens or increases the determination period by adding an additional value of a predetermined fixed value (S552), stores the travel information in the SRAM 28 (S554), sets the storage history flag to “1” (S556), and ends the present process.

When the determination at S548 is “Yes” in the status of “0”, the storage history flag is set to “1”. The status of “1” continues until one of the determinations at S540, S542, and S544 becomes “No.” The storage history flag is set to “0”, when one of the determinations at S540, S542, and S544 is “No.”

Therefore, during the status of “1” of the storage history flag, even if the value of the condition satisfying counter is longer than the determination period (S548: Yes), the process at S554 is not executed and the travel information is not stored. When one of determinations at S540, S542, and S544 is “No”, and the value of the condition satisfying counter is greater than a predetermined period (S558: Yes), the ECU 20 increments a both-pedals stepped-on counter (S560). If the value of the condition satisfying counter is less than the predetermined period (S558: No), the process advances to S562. The predetermined period is, for example, set to 100 ms.

The state where both the accelerator pedal and the brake pedal are stepped on during the travel of the vehicle continues for a continued period that is longer than the predetermined period. This state does not arise in a usual driving operation, and this state is defined as an anomalous vehicle behavior of the both-pedals stepped-on. The both-pedals stepped-on counter is provided to count the number of the anomalous vehicle behaviors of the both-pedals stepped-on. If the value of the both-pedals stepped-on counter is equal to or greater than a predetermined number, the vehicle behavior of both the accelerator pedal and the brake pedal being stepped on during the travel of the vehicle is supposed to result from an intentional driving operation of the driver instead of resulting from the vehicle.

At S562 and S564, the ECU 20 clears the condition satisfying counter and the storage history flag to set to “0” and ends the present process. In the travel information storage process 4 of FIG. 7, the ECU 20 or the CPU 22 may function as a behavior determination section, device, or means by executing the process at S540 to S544, and S548, may function as a travel information storage section, device, or means by executing the process at S554, and may function as a period change section, device, or means by executing the process at S552, S558, and S560.

(Learnt Value Storage Process 3)

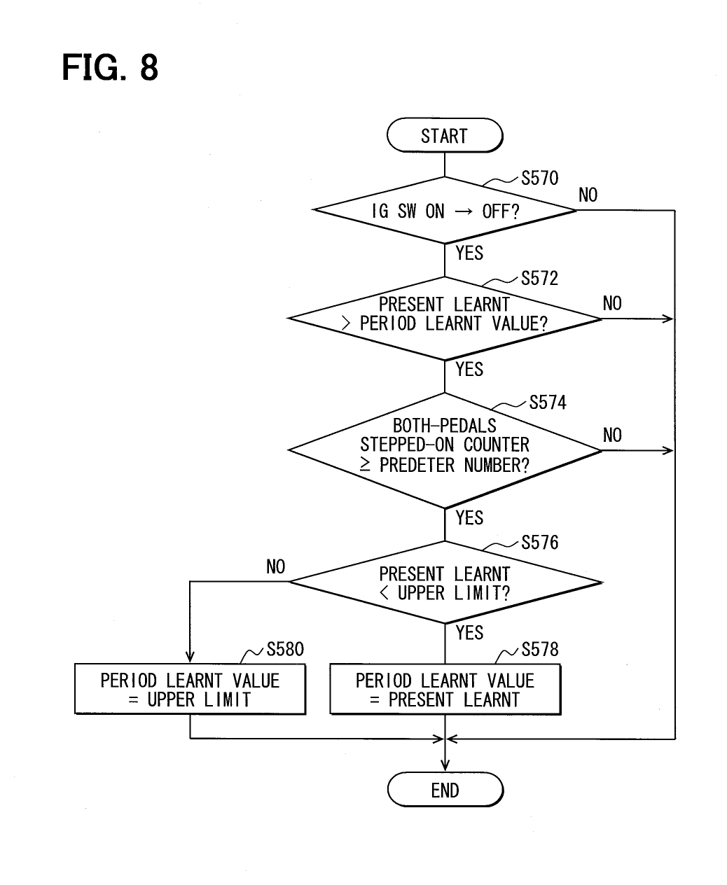

FIG. 8 is a flowchart of a learnt value storage process 3 for a determination period at the time of stopping the engine (also referred to as at the engine stop time point) corresponding to the travel information storage process 4 of FIG. 7.

The process at S570, S572, S576 to S580 in FIG. 8 is substantially the same as the process at S430 to S438 in FIG. 3A. In the learnt value storage process 3 of FIG. 8, the ECU 20 determines whether the value of the both-pedals stepped-on counter is equal to or greater than a predetermined number at S574. The predetermined number is, for example, set to five.

As mentioned above, the both-pedals stepped-on counter counts how many times the anomalous vehicle behavior of the both the accelerator pedal and brake pedal being stepped on during the travel of the vehicle arises in one trip.

When the value of the both-pedals stepped-on counter is equal to or greater than the predetermined number and, thus, the vehicle behavior of both the accelerator pedal and the brake pedal stepped on during the travel of the vehicle occurs frequently, it is supposed that the driver intentionally steps on both the accelerator pedal and the brake pedal. Such a driving operation is considered to be the driver's peculiarity; thus, there is a high possibility to occur for each trip.

When it is thought that the anomalous vehicle behavior occurs because of the driver's intentional manipulation, repeatedly storing of the travel information at that time is desirably to be avoided. It is desirable to hand over the present learnt determination period to the next trip to thereby suppress the storage of the travel information.

In contrast, when the value of the both-pedals stepped-on counter is less than the predetermined number, the anomalous vehicle behavior of both the accelerator pedal and the brake pedal stepped on during the travel of the vehicle is not regarded as the driving operation made intentionally by the driver. For example, it is thought that it results from the vehicle cause such as the state where the accelerator pedal is caught by something and not returning.

In this case, in order to avoid repeatedly storing the travel information during the present trip, the determination period is lengthened. In contrast, in order to analyze the occurrence cause, it is desirable to store the travel information when the anomalous vehicle behavior is considered to occur also at the next trip because of the vehicle. Therefore, it is not desirable to hand over the present learnt determination period to the next trip to lengthen the determination period also at the next trip.

Thus, in the learnt value storage process 3 of FIG. 8, when the value of the both-pedals stepped-on counter is equal to or greater than the predetermined number (S574: Yes), the vehicle behavior of both the accelerator pedal and the brake pedal being stepped on during the travel of the vehicle is supposed to result from an intentional driving operation of the driver. In such a case, the process at S576 to S580 is executed, and the present learnt determination period is taken over to the next trip.

In contrast, when the value of the both-pedals stepped-on counter is less than the predetermined number (S574: No), it is supposed that the vehicle behavior of both the accelerator pedal and the brake pedal stepped on during the travel of the vehicle occurs because of the vehicle. In this case, the present process is ended, and the present learnt determination period is not taken over to the next trip.

In the learnt value storage process 3 of FIG. 8, the ECU 20 or CPU 22 may function as a period change section, device, or means by executing the process at S572 to S580. In the present embodiment described above, the ECU 20 may be also referred to as an electronic control apparatus, and the SRAM 28 or EEPROM 30 may be referred to as a storage portion.

Further, the ECU 20 realizes the function of the behavior determination section, device, or means, the travel information storage section, device, or means, the period change section, device, or means, and the condition change section, device, or means.

### Other Embodiments

In the above embodiment, the travel information is stored in the storage portion of the ECU. In contrast, the travel information may be stored in a storage portion other than the storage portion of the ECU.

In addition, the travel information may be stored in not only the SRAM 28 or EEPROM 30, but also any storage portion that can store data under the driving stop of the vehicle. The present disclosure may apply to any one of a vehicle that has as a driving source an internal-combustion engine such as a gasoline engine or a diesel engine, a hybrid vehicle has as a driving source both an internal-combustion engine and a motor, and an electric vehicle has as a driving source a motor.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. An electronic control apparatus for a vehicle, the electronic control apparatus comprising:
a behavior determination section to determine whether an anomalous vehicle behavior, which satisfies a determination condition, continuously arises for a continued period that is longer than a determination period;
a travel information storage section to store, in a storage portion, travel information of the vehicle at a time when the behavior determination section determines that the anomalous vehicle behavior continuously arises for the continued period longer than the determination period; and
a period change section to change the determination period to a lengthened determination period by lengthening the determination period in cases that the behavior determination section determines that the anomalous vehicle behavior continuously arises for the continued period longer than the determination period.

2. The electronic control apparatus according to claim 1, wherein:
the period change section lengthens the determination period by a predetermined fixed value.

3. The electronic control apparatus according to claim 1, wherein:
the period change section defines, as the lengthened determination period, the continued period for which the anomalous vehicle behavior satisfying the determination condition continuously arises actually longer than the determination period.

4. The electronic control apparatus according to claim 1, wherein:
the period change section defines an upper limit value as the lengthened determination period when the lengthened determination period exceeds the upper limit value.

5. The electronic control apparatus according to claim 1, further comprising:
a condition change section to change a threshold value of the determination condition such that it is more difficult for the vehicle behavior to satisfy the determination condition, in cases that the behavior determination section determines that the anomalous vehicle behavior continuously arises for the continued period longer than the determination period.

6. The electronic control apparatus according to claim 5, wherein:
the condition change section defines an upper limit value as the threshold value in cases that the threshold value that is changed exceeds the upper limit value.
